(19) United States
(12) Patent Application Publication
(10) Pub. No.: US 2006/0015390 A1
(43) Pub. Date: Jan. 19, 2006

(54) System and method for identifying and approaching browsers most likely to transact business based upon real-time data mining

(76) Inventors: Vikas Rijsinghani, Atlanta, GA (US); Gregg Freishtat, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 10/980,613

(22) Filed: Nov. 3, 2004

Related U.S. Application Data
(63) Continuation-in-part of application No. 09/922,753, filed on Aug. 6, 2001.
(60) Provisional application No. 60/244,039, filed on Oct. 26, 2000.

(51) Int. Cl. G06Q 20/00

(52) U.S. Cl. 705/10

(57) ABSTRACT

The present invention is directed to a system and functionality that removes the guess work out of trying to determine which browsers on a web site are more likely to end up with a good disposition. One approach introduced by the present invention is to first make sure the sales server captures as much information about browsers as is possible with respect to their activity on the website/ecommerce server. Then the server enables the enterprise to use business rules to define the population of browsers that are eligible for chat invitations. Out of this population, the server, on behalf of individual agents, approaches browsers as randomly as possible. As agents are entering into engagements and recording their disposition codes, the server periodically determines if it can identify any patterns in behavior of those engagements that end up with a good disposition code. For example, the server may note that browsers who were invited to chat in the 8th minute of their session and those who had seen 2 product pages end up in good engagements four times more often than the average browser. Once a sufficient sample set of engagements is conducted to allow the server to develop a statistically valid profile/model of browsers who end up with good engagements, the server compares all new browsers against this model and provides a numeric number representing how close the new browser is to the model. This number, called a score, is then used by the system to sort the browsers in real time and used as the criteria as to who should be approached and in which order.

### CROSS-REFERENCE TO RELATED APPLICATIONS

This application claims priority to U.S. Utility patent application Ser. No. 09/922,753, filed Aug. 6, 2001, which in turn claims priority to U.S. Provisional Patent Application No. 60/244,039, filed Oct. 26, 2000, both of which are incorporated herein in their entirety by reference thereto.

### BACKGROUND OF THE INVENTION

1. Field of the Invention

The present invention relates generally to conducting business transactions on-line, and more specifically to identifying the most valuable browsers on one or more web sites in order to prioritize which browsers to approach.

2. Background of the Invention

Sales server technology is known whereby an enterprise may observe browser activity on its web site or ecommerce server, write business rules that segment the browsers into various categories, and enable agents to proactively send chat invitations to enter into a sales or service conversation. For example, co-pending U.S. patent application Ser. No. 09/922,753, filed Aug. 6, 2001, entitled “Systems and Methods to Facilitate Selling of Products and Services”, which is commonly owned by the present assignee, describes an example of this type of system.

In such a system, after the invitation to chat is received, the browser can elect to Accept the invitation, Decline the invitation, or Ignore the invitation. If the browser accepts the invitation, then the agent and browser may conduct their conversation, and upon completion the agent may enter into the sales server an epilogue to the chat record, and assign the engagement a disposition code. Disposition codes are essentially indicators on how the engagement went, for example:
Just Browsing
Requested Callback
Requested More Information
Hot Lead
Sale

In order to maximize the productivity of the agents, enterprises have attempted to write business rules that attempt to optimize the agents' time. Administrators in the enterprise try to intuitively draft criteria which they feel are indicators of a browser's propensity to end up with a good disposition. Invariably, these criteria are almost always wrong. In fact, using such a technique, criteria upon criteria may be created, and after a while one can logically determine the effectiveness of these rules that are created due to their complexity and interdependencies.

### SUMMARY OF THE INVENTION

As a response to this scenario, the present invention is directed to a system and functionality that removes the guess work out of trying to determine which browsers are more likely to end up with a good disposition. One approach introduced by the present invention is to first make sure the sales server captures as much information about browsers as is possible with respect to their activity on the website/ecommerce server. Then the server enables the enterprise to use business rules to define the population of browsers that are eligible for chat invitations. Out of this population, the server, on behalf of individual agents, approaches browsers as randomly as possible. As agents are entering into engagements and recording their disposition codes, the server periodically determines if it can identify any patterns in behavior of those engagements that end up with a good disposition code. For example, the server may note that browsers who were invited to chat in the 8th minute of their session and those who had seen 2 product pages end up in good engagements four times more often than the average browser. Once a sufficient sample set of engagements is conducted to allow the server to develop a statistically valid profile/model of browsers who end up with good engagements, the server compares all new browsers against this model and provides a numeric number representing how close the new browser is to the model. This number, called a score, is then used by the system to sort the browsers in real time and used as the criteria as to who should be approached and in which order.

The invention can also take into account information that extends beyond the browser's behavior on the web site by interfacing with other data sources, such as customer records in the enterprise, to provide the modeling process additional information to analyze.

Furthermore, the invention can also use specific browser behavior on the website to determine if browsers have ended up in good engagements, such as completion of a transaction online during or after the chat conversation. This can be derived by observing the clickstream collected or provided by the enterprise during the modeling process.

### BRIEF DESCRIPTION OF THE DRAWINGS

The accompanying drawings, which are incorporated in and constitute a part of this specification, illustrate embodiments of the invention, and together with the description, serve to explain the principles of the invention.

FIGS. 1A and 1B are block diagrams illustrating the overall architecture of the present invention.

FIG. 1C is a diagram illustrating examples of the various types of attributes, behaviors and agent feedback that may be modeled by the real time data mining engine.

FIG. 1D illustrates the process of scoring a new browser on a web site.

FIG. 1E illustrates how browsers may be sorted by score, and how agents may thereafter approach the browsers.

FIG. 2 is a process diagram illustrating the overall operation of the present invention.

### DETAILED DESCRIPTION OF THE INVENTION

One or more preferred embodiments of the invention are now described in detail below and in the attachments hereto. Referring to the drawings, like numbers indicate like elements and steps throughout the figures.

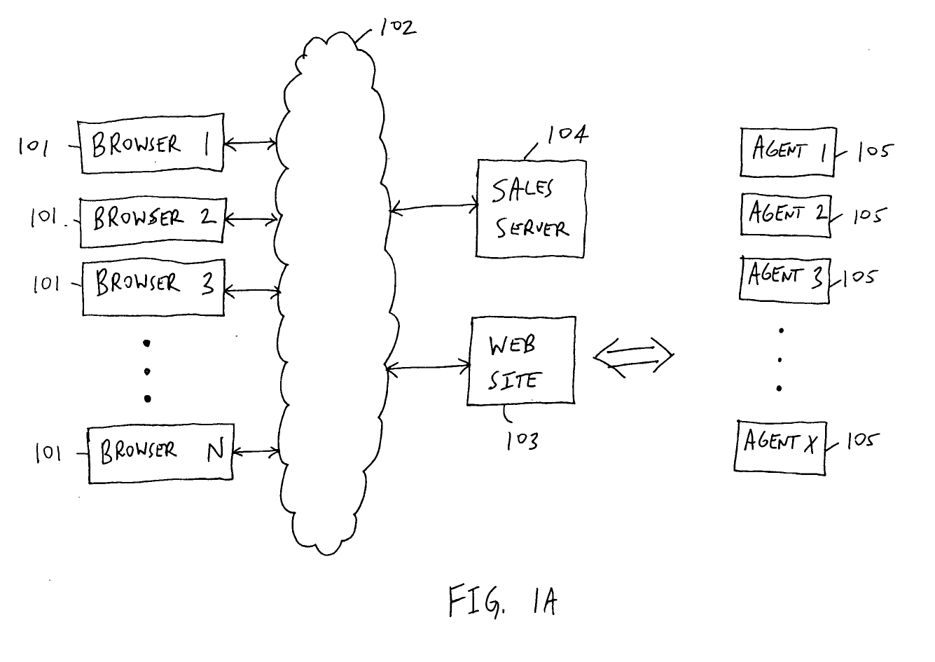

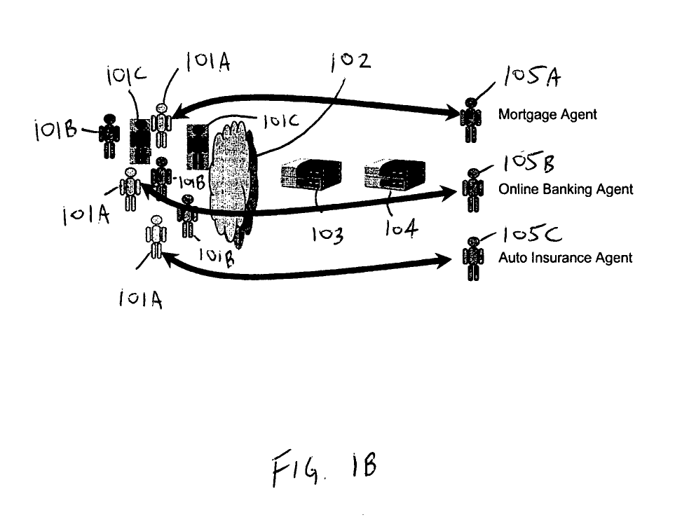

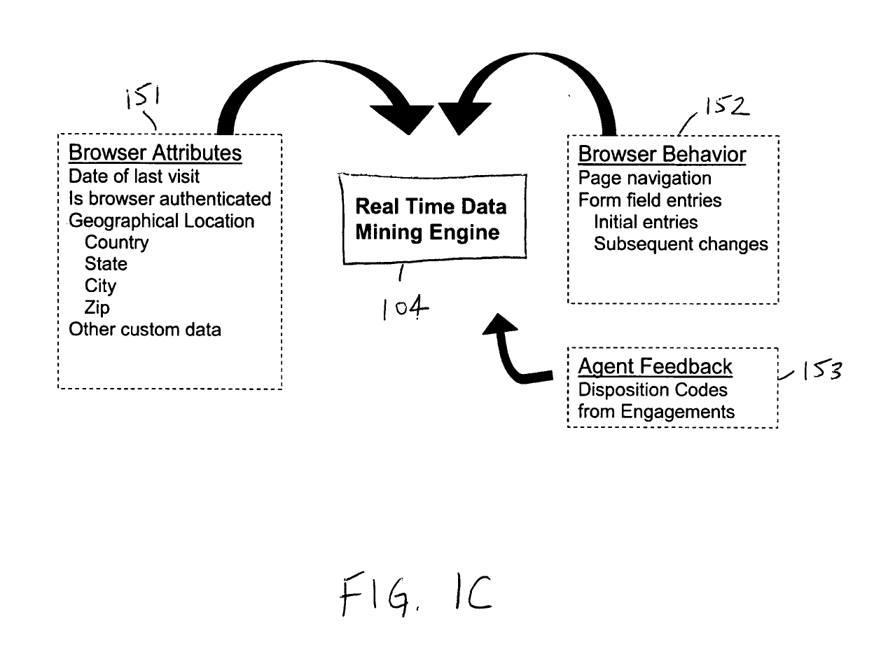

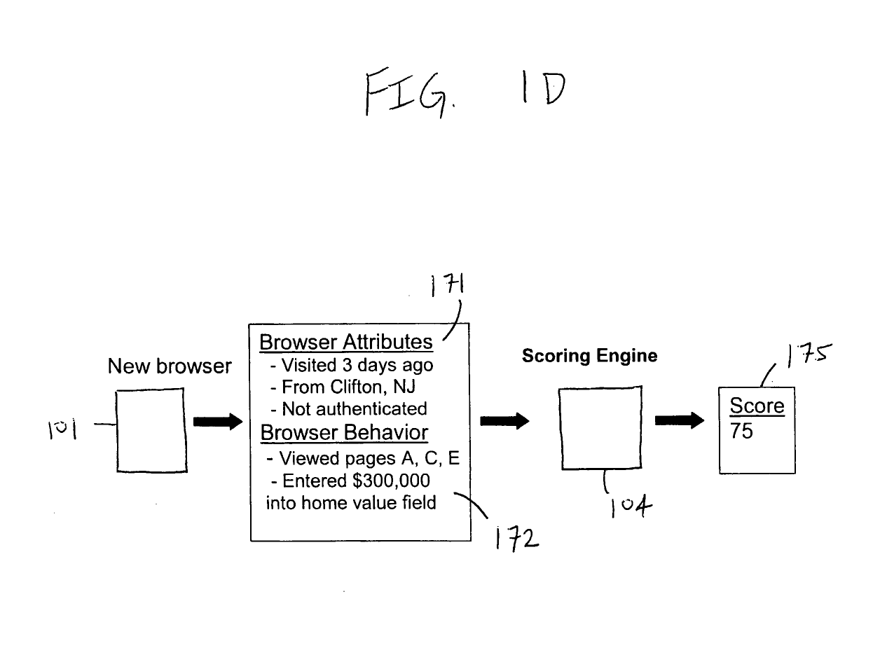

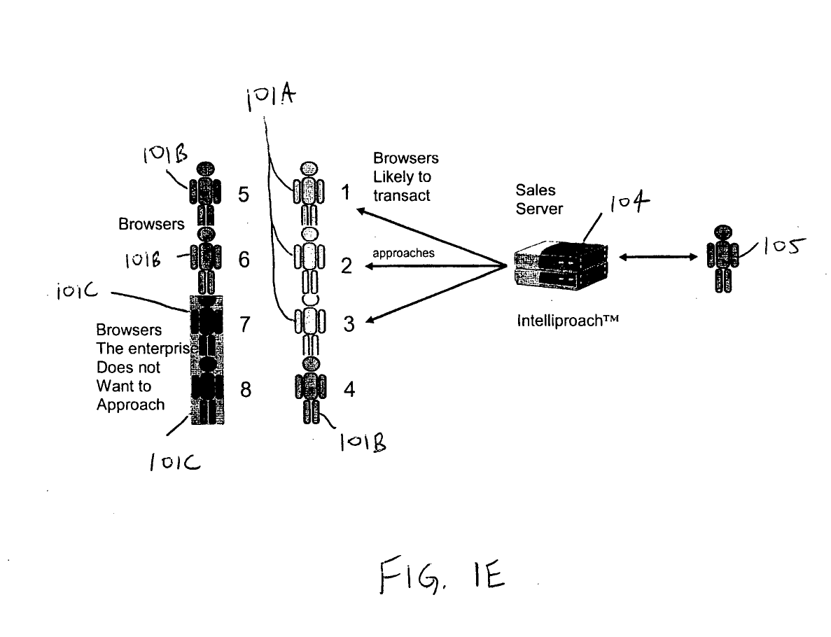

FIGS. 1A and 1B are block diagrams depicting the overall structure of the present invention in one embodiment. Browsers 101 (corresponding to 101A, 101B, 101C in FIG. 1B), using commonly available browser software such as Internet Explorer, Netscape, etc., visit one or more web sites 103 through, for example, the Internet 102, and view information regarding products or services available via the web site 103. The browsers 101 may comprise consumers operating a personal computer running a software browser, such as Internet Explorer. The web site 103 may operate as a web server, using one of the various types of available e-commerce engines, including but not limited to static web sites, dynamic web sites that provide individualized content to browsers, and web sites that conduct transactions such as purchasing products or filling out forms for data capture.

A sales server 104 (such as the Proficient Sales Server available from Proficient Systems, Inc., Atlanta, Ga.—www.proficient.com—the assignee of the present patent application) may be coupled to the web server 103, and one or more agents 105 (such as sales agents) may operate personal computers (PCs) or the like coupled to the sales server 104.

The sales server 104 can operate on any operating system and any hardware platform, such as those that supports JAVA, C, and C++ environments. This includes, but is not limited to, Windows, Linux, Solaris, AIX, etc. In one embodiment, the sales server 104 may utilize the platform, operating system and development platform as described in detail with respect to system 10 in co-pending U.S. patent application Ser. No. 09/922,753, filed Aug. 6, 2001, and entitled “Systems and Methods to Facilitate Selling of Products and Services”, which is incorporated herein in its entirety by reference thereto.

The web site 103 may be focused on any type of activity, including the sale of products or services, the provision, collection and/or communication of information, etc. The present invention is not limited in this respect—it may be used in conjunction with any type of web site 103 or server that may be accessed by browsers 101, or equivalents thereof. Also, the present invention can be targeted towards any type of outcome, and if there is a predictive attribute(s) associated with the browser's 101 session, the invention will discover it automatically and subsequently score new browsers 101 against that attribute(s).

Specifically, the real-time data mining engine (implemented by sales server 104) of the present invention enables operators of web sites 103 to scientifically and automatically identify the most valuable browsers 101A (see FIG. 1B, described further below) on the web sites 103. Additionally, this engine may be used to identify the most valuable browsers 101A across multiple web site 103, within or outside one or more enterprises. “Value” can mean nearly anything—from “likely to apply for a loan”, to “likely to buy a TV”, to “accepting customer service”, etc. The present invention may also solve for multiple values at once, depending upon the need of the operator of the web site 103.

FIG. 1B depicts a graphical representation of the type of activity the present invention is designed to facilitate. Browsers 101A, 101B and 101C represent the world of browsers who may connect to the web site 103 through the Internet 102. Browsers 101A represent those browsers who are deemed likely to transact business on the web site 103. In contrast, browsers 101C represent those browsers who the operators of the web site 103 do not wish to approach to conduct business on the web site 103. For example, if the web site 103 is offering mortgages, such browsers 101C may be those with bad credit scores. Finally, browsers 101B represent those browsers who may transact business on the web site, but whose behavior or attributes don't make them high value targets.

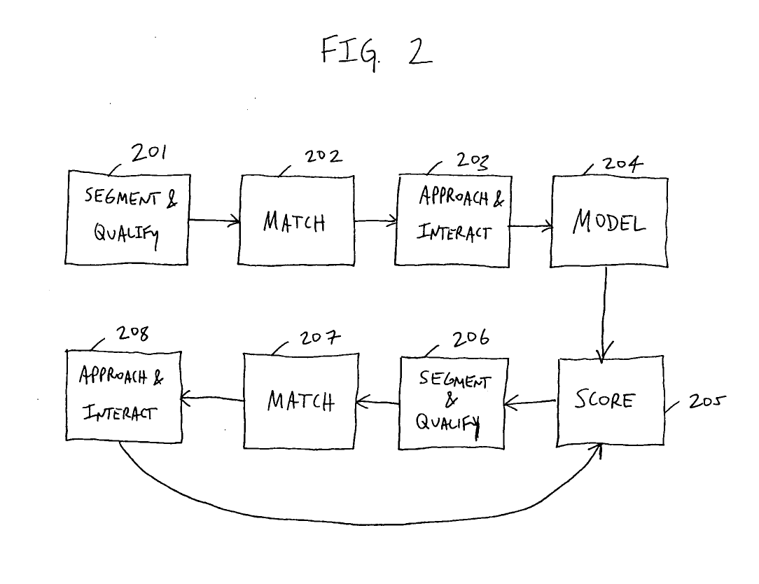

FIG. 2 depicts the process performed by the sales server 104, in one embodiment (with reference to step numbers of FIG. 2):

Step Explanation
201 SEGMENT and QUALIFY—Once deployed and ready to go, the server 104 segments the online browser 101 population based on a set of predefined business rules identified by the enterprise operating the web site 103.
202 MATCH—The set of segmented and qualified opportunities from step 201 are matched to specific agents 105 or agent pools.
203 APPROACH/INTERACT RANDOMLY—The agent 105 then has the option of manually examining the list of valid browser 101 opportunities that are matched to his/her skill set and selecting individual browsers 101 to approach, OR, the agent 105 can put the system into automatic approach mode (Intelliproach™) where the server 104 will automatically approach browsers 101 from the pool of qualified individuals. The agent 105 in this case is responsible for tagging the end of the engagement with a code that represents the disposition code of the engagement. Disposition codes are a set of codes that categorize and indicate the end result of an engagement.
204 MODEL—In order to for the server 104 to create a model, a sufficient number of ‘GOOD’ engagements need to be conducted. Good engagements are defined as those engagements with browsers 101 that were tagged by agents 105 with certain disposition codes, or those engagements in which browsers 101 ultimately completed a transaction online, or those engagements in which the enterprise has tracked/determined that a transaction has occurred at a later date. The server 104 will examine the attributes of all of the browsers 101 and based on whether they were flagged as GOOD engagements, identify the attributes that most contribute to predicting the propensity to transact (such as using a regression analysis). This information is then converted into a model for subsequent scoring.
205 SCORE—Once a model is created, all subsequent browsers 101 are evaluated against that model and given a numeric score every X seconds. X depends on the nature of the implementation, but is typically every 6-10 seconds. This score is used to rank order all of the browsers 101 on the website 103.
At this point, the cycle goes to the SEGMENT and QUALIFY step 206 (similar to step 201), the MATCH step 207 (similar to step 202), and the APPROACH AND INTERACT STEP 208 (similar to step 203), and then the cycle is repeated at step 205. Future approach decisions will take into account the rank order provided by the SCORING step 205 and decide to approach those with the highest scores first.

As described above in steps 203 and 208, in one embodiment, the model is created by having agents 105 in conjunction with the server 104 randomly approach browsers 101 until a statistically relevant number of interactions are collected for browsers who perform a transaction having a desired value. The interactions may be initiated through “pop-up” windows or “click for assistance” buttons, along with accompanying on-line chat, telephone communications or co-browsing as needed.

For example, for a bank operating the web site 103, “value” may be defined as having a browser 101 apply for a loan. Other non-exhaustive examples may include:
The browser 101 is approved for a loan
The browser 101 takes out the loan and pays on time during each of the first six months
The browser 101 is approved for a loan over $1,000,000

Co-pending U.S. patent application Ser. No. 09/922,753, filed Aug. 6, 2001, entitled “Systems and Methods to Facilitate Selling of Products and Services”, as well as co-pending U.S. patent application Ser. No. 09/742,091, filed Dec. 22, 2000, entitled “Method and System of Collaborative Browsing” disclose various techniques for allowing agents to approach browsers, along with accompanying on-line chat, phone and co-browsing communications, and are both incorporated herein in their entirety by reference thereto. These patent applications are commonly assigned to the assignee of the present application.

FIG. 1C graphically depicts the type of data that is used to create the model in step 204. Browser attributes 151, browser behavior 152 and agent feedback 153 are all attributes and characteristics that are collected by the real time data mining engine (sales server) 104 as the model. In the example of FIG. 1C, the browser attributes include data such as: date of last visit, authentication of browser 101, geographic location of browser 101, and/or other custom data. Browser behavior may include page navigation by the browser 101 and form field entries. Agent feedback may include disposition codes that agents 105 may use when initially approaching a random sampling of browsers 101, and determining what type of transactions (if any) the browsers performed while at the web site 103. The disposition codes may include “completed transaction”, “started but not completed transaction”, and are a set of codes into which the enterprise wants to categorize the end results of engagements. They may vary from implementation to implementation. Some further examples may be:
Just Browsing
Requested Callback
Requested More Information
Hot Lead
Sale

Any data used in the modeling of step 204 should be as random as possible, in order to achieve the best results. Preferably, there should be no rules that bias one type of browser 101 versus another, nor should a human use his/her intuition to bias the sample set by proactively approaching browsers. The enterprise operating the web site 103 can exclude certain types of browsers (for example those with bad credit), but any exclusion that exists in the sampling data should preferably exist in the real-time environment. Specifically, this means if you, for example, exclude people with bad credit in the sample set, you should continue to exclude people with bad credit when you score new browsers 101. Moreover, in one embodiment, a certain number of browsers 101 may continue to be randomly approached in order to maintain the integrity of the model. The size of this random pool will depend largely on the “lift” provided by the model and how fast models deteriorate or become stale. “Lift” is computed as the increase in conversion rate while using a scoring engine when compared to a completely random selection process. If 100% of the on-line browser population is approached, then the left will be zero.

The engine 104 typically requires a sufficient amount of data before a meaningful regression analysis may be performed in step 204 (described further below). In one embodiment, agents 105 may randomly approach browsers 101 until a set number of approaches (e.g., 500-1000 approaches) and corresponding dispositions occur. In another embodiment, agents 105 may conduct a sufficient number of engagements with browsers 105 until they reach a set number (say 500-1000) of “good” engagements (e.g., completed transactions).

In step 204, a regression analysis is performed which determines the most common attributes of browsers 101 who are deemed to be “valuable”. In one embodiment, the attributes on which the regression analysis is performed are completely unbiased and untouched by any manual process—the attribute data is collected automatically. Moreover, the attributes which end up being common among those browsers 101 who have performed a transaction having value may vary for each web site 103, depending upon what attributed are collected for that web site 103. For example, suppose the following attributes are collected for browsers 101 on a web site 103:
IP address
Time of day
Time on site
Values input into an on-line form
Page navigation details
Version of software browser
Geography

These attributes collected for this web site 103 may be different than attributes collected for a different web site 103. Nevertheless, if it turns out over time that certain values for some of these attributes are common for browsers 101 on the web site 103, then the regression analysis performed in step 204 will identify such common attributes.

In addition to attributes or characteristics captured by the web site 103, the present invention may also collect and perform a regression analysis on attributes collected from third-party sources, such as an eCRM file, third-party databases (such as credit reports), and the like. In sum, virtually any data associated with a browser 101 may be collected and evaluated in an unbiased manner. The present invention will simply perform a regression analysis (in step 204) on any and all such data, and will determine the most common attributes of this set of data, thereby solving for the commonalities of all browsers 101 who end up performing the designated transaction having value.

A regression analysis tool may be used to perform the regression analysis in step 204. Logistical Regression with Sequence Analysis may be used to perform the actual regression and generate a scoring engine. In one embodiment, the regression tool used may be KXEN, published by KXEN of Paris, France.

The present invention may be configured to target different types of behavior, including a browser's 101 propensity to accept approaches by agents 105, or a browser's propensity to perform a transaction on the web site 103 having a high value. Which type of behavior is targeted may be based on the volume of activity by agents 105, and the business objectives of the enterprise operating the web site 103.

In step 204, once the regression analysis is complete and a list of common attributes has therefore been created, the list may be sorted if needed. For example, the list of attributes may be sorted in order of importance, whereby the most common attribute is listed first.

Also in step 204, the server 104 creates a model of the most common attributes, and stores it in memory. The server 104 may perform this modeling periodically, and when there is a critical mass of data, in step 205, it will then automatically begin to score new browsers 101 against the model.

In step 205, the server 104 compares every new browser 101 on the web site 103 (or plurality of web sites 103) with the stored model in real time (every few seconds or so). Based upon how similar the new browsers 101 are in comparison with the stored model, each new browser 101 is scored (most valuable=highest score). As the browsers/potential customers 101 continue to interact with the web site 103, the score may be continuously updated.

The scoring process of step 205 is shown graphically in FIG. 1D, whereby the new browser 101 has certain attributes 171 and behavior 172. In this example, the new browser 101 visited the web site 103 three days ago, and lives in Clifton, N.J. In this case, the new browser 101 is not authenticated—for example, the new browser 101 may not have registered and logged into the web site 103, whereby the web site 103 would have had some degree of confidence as to the browser's true identity. Also, in this case, the new browser 101 has viewed pages A, C and E of the web site during this session, and has entered the value $300,000 into the “home value” field of a form. The scoring engine 104 thereafter scores (step 205) the new browser 101 against the model stored in step 204, and a score 275 is created.

After the scores 175 for the new browsers 101 are calculated, the scores are used to determine who to approach (by an agent 105) and when. With reference to FIG. 1E, once the new browsers 101A, 101B and 101C are scored in step 205, the server 104 may sort these browsers in order of likelihood to perform a high-value transaction. In the example of FIG. 1E, the most likely browsers 101A to transact are scored 1, 2 and 3, the middle group 101B is scored 4, 5 and 6, and the browsers 101C the enterprise that operates the web site 103 does not want to approach are scored 7 and 8.

The sorted list of new browsers 101 may then be fed into a server (either the server 104, or a separate server), such as the Intelliproach™ server available from Proficient Systems, Inc., Atlanta, Ga., the assignee of the present patent application. This server will then automatically approach the highest-scored browsers 101, on behalf of agents 105, in order to maximize the likelihood of the designated high-value transactions.

Because scores may change for browsers during their session (based upon changes in attributes and behaviors over time), the server 104 may periodically re-score and re-sort new browsers 101, and thus re-prioritize which browsers 101 to approach first.

In sum, through a combination of business-defined rules and a real time data mining engine, the sales server 104 operates to connect the best browser 101A opportunities to the most appropriate agent 105. Rules may be used to implement business constraints—for example, identifying browsers 101C that the operator of the web site 103 does not want to engage (e.g., those with bad credit, etc.). Rules may also be used to implement routing requirements (e.g., browsers 101A who are potential mortgage customers will be routed to mortgage agents 105A and not on-line insurance agents 105C, etc.). Over time, the sales server 104 of the present invention will learn to identify the behavior of browsers 101A who are most likely to successfully transact business on the web site 103 (out of the universe of browsers 101B who may not be the best, and browsers 101C who the operator of the web site 103 does not want to approach).

1. A method for identifying and approaching high value browsers on a web site, the method comprising the steps of:
a. selecting a type of high value transaction associated with the web site;
b. identifying a plurality of browsers that have performed on the web site a transaction of the high value transaction type;
c. storing a set of attributes associated with each of the identified plurality of browsers;
d. generating the most common attributes of the stored set;
e. comparing attributes of a new browser on the web site to the generated most common attributes of the stored set; and
f. approaching the new browser if the attributes of the new browser are similar to the generated most common attributes of the stored set.

2. The method of claim 1, wherein the most common attributes of the stored set are generated using a regression analysis.

3. The method of claim 1, wherein the type of high value transaction represents a purchase of a product or service from the operator of the web site.

4. The method of claim 1, wherein the approaching step is performed by a sales agent.

5. The method of claim 1, wherein the identifying step is performed by randomly approaching browsers, and recording the stored set of attributes associated with the randomly approached browsers.

6. A method for identifying and approaching high value browsers on a web site, the method comprising the steps of:
a. selecting a type of high value transaction associated with the web site;
b. randomly approaching a plurality of browsers on the web site, in order to identify a selected plurality of the browsers that have performed a transaction of the high value transaction type;
c. storing a set of attributes associated with each of the identified selected plurality of browsers;
d. performing a regression analysis on the stored set, thereby obtaining the most common attributes of the stored set;
e. comparing attributes of a new browser on the web site to the generated most common attributes of the stored set; and
f. approaching the new browser by a sales agent if the attributes of the new browser are similar to the generated most common attributes of the stored set.

7. A system for identifying and approaching high value browsers on a web site, the system comprising:
a. a database; and
b. a processor for performing the steps of:
i. selecting a type of high value transaction associated with the web site;
ii. identifying a plurality of browsers that have performed on the web site a transaction of the high value transaction type;
iii. storing in the database a set of attributes associated with each of the identified plurality of browsers;
iv. generating in the database the most common attributes of the stored set;
v. comparing attributes of a new browser on the web site to the most common attributes of the stored set; and
vi. approaching the new browser if the attributes of the new browser are similar to the generated most common attributes of the stored set.

8. The system of claim 7, wherein the most common attributes of the stored set are generated using a regression analysis.

9. The system of claim 7, wherein the type of high value transaction represents a purchase of a product or service from the operator of the web site.

10. The system of claim 7, wherein the approaching step is performed by a sales agent.

11. The system of claim 7, wherein the identifying step is performed by randomly approaching browsers, and recording the stored set of attributes associated with the randomly approached browsers.

12. A system for identifying and approaching high value browsers on a web site, the system comprising:
a. a database; and
b. a processor for performing the steps of:
i. selecting a type of high value transaction associated with the web site;
ii. randomly approaching a plurality of browsers on the web site, in order to identify a selected plurality of the browsers that have performed a transaction of the high value transaction type;
iii. storing in the database a set of attributes associated with each of the identified selected plurality of browsers;
iv. performing a regression analysis on the set stored in the database, thereby obtaining the most common attributes of the stored set;
v. comparing attributes of a new browser on the web site to the generated most common attributes of the stored set; and
vi. approaching the new browser by a sales agent if the attributes of the new browser are similar to the generated most common attributes of the stored set.

13. A computer-readable storage medium containing a set of instructions for execution by a computer, the set of instructions for performing the steps of:
a. selecting a type of high value transaction associated with the web site;
b. identifying a plurality of browsers that have performed on the web site a transaction of the high value transaction type;
c. storing a set of attributes associated with each of the identified plurality of browsers;
d. generating the most common attributes of the stored set;
e. comparing attributes of a new browser on the web site to the generated most common attributes of the stored set; and
f. approaching the new browser if the attributes of the new browser are similar to the generated most common attributes of the stored set.

14. A computer-readable storage medium containing a set of instructions for execution by a computer, the set of instructions for performing the steps of:
a. selecting a type of high value transaction associated with the web site;
b. randomly approaching a plurality of browsers on the web site, in order to identify a selected plurality of the browsers that have performed a transaction of the high value transaction type;
c. storing a set of attributes associated with each of the identified selected plurality of browsers;
d. performing a regression analysis on the stored set, thereby obtaining the most common attributes of the stored set;
e. comparing attributes of a new browser on the web site to the generated most common attributes of the stored set; and
f. approaching the new browser by a sales agent if the attributes of the new browser are similar to the generated most common attributes of the stored set.
